(19) United States
(12) Patent Application Publication
(10) Pub. No.: US 2009/0048363 A1
(43) Pub. Date: Feb. 19, 2009

(54) RADIOSENSITIVE SUBSTANCE

(75) Inventors: Patrick Glockner, Haltern am See (DE); Michael Ewald, Marl (DE); Peter Denkinger, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa GmbH, Dusseldorf (DE)

(21) Appl. No.: 11/574,197

(22) PCT Filed: Jul. 28, 2005
(86) PCT No.: PCT/EP2005/053678

§ 371 Date: Jan. 11, 2008

(30) Foreign Application Priority Data
Aug. 26, 2004 (DE) 10 2004 041 197.2

(51) Int. Cl. C09D 161/02; C08L 61/02; C09D 7/12; C09D 11/00; C09D 17/00

(52) U.S. Cl. 522/10; 525/521; 522/140; 522/8; 522/30; 522/28; 522/29; 524/592

(57) ABSTRACT

A description is given of radiation-sensitive compositions composed of a binder component and low-odor polymeric reaction products composed of the reaction product of aldehydes and ketones.

The invention relates to a low-odor, radiation-sensitive composition, composed of a binder and radiation-sensitive polymers, a process for preparation thereof, and the use thereof as low-volatility photoinitiator.

Radiation-curable coating materials have increasingly gained an importance within recent years, on account of the low VOC (volatile organic compounds) content of these systems. The film-forming components in the coating material are of relatively low molecular mass and hence of low viscosity, so that there is no need for high fractions of organic solvents. Durable coatings are obtained by the formation, following application of the coating material, of a high molecular mass, polymeric network by means of crosslinking reactions initiated, for example, by UV light or electron beams. Formation of the network results in volume contraction, which is said in the literature to be a reason for the sometimes poor adhesion of radiation-curable coating materials to different substrates [Surface Coatings International Part A, 2003/06, pp. 221-228].

The film-forming components are generally binders composed of polymers containing unsaturated moieties. A review article of the various polymers commonly employed today appears in Ink World, July 2003, p. 14 f.

The binders crosslink, for example, by a radical or cationic mechanism. This reaction is initiated by UV light, by virtue of the presence of photosensitive compounds, known as photoinitiators, accompanied where appropriate by photosensitizers, which breakdown into free radicals.

The photoinitiators commonly used today may come, for example, from the group of the benzophenones, α-hydroxy ketones, α-amino ketones, monoacylphosphine oxides or bisacyl ketones. Relevant literature includes, for example, Journal of Coatings Technology, Vol. 65, No. 819, April 1993, p. 49 ff., Surface Coatings International, 1999 (7), p. 344 ff., and Farbe und Lack, 7/97, p. 28 ff.

Radiation-sensitive compounds which may contain, where appropriate, an acetophenone submoiety, and polymeric derivatives containing acetophenone moieties, are described in EP 0 346 788. EP 0 377 199 and DE 102 06 987.

EP 0 346 788 describes ethylenically unsaturated, copolymerizable, radiation-sensitive organic compounds which carry at least one (meth)acrylic ester group. EP 0 377 199 describes UV-crosslinkable compositions based on (meth)acrylic ester copolymers.

Ester moieties are not stable to hydrolysis, and so there is a process of polymer degradation which is promoted by hot, moist ambient conditions, especially in the presence of acidic or basic compounds.

The vinyl ether derivatives that are described in DE 102 06 987 can form hydroperoxides with atmospheric oxygen, and these hydroperoxides may then initiate unwanted premature polymerization and lead to aging of the crosslinked polymers. The acid environment, moreover, does not assure stability.

Ketone-aldehyde resins are used in coating materials as, for example, unhydrolyzable additive resins, in order to enhance certain properties such as gloss, hardness or scratch resistance. On account of their relatively low molecular weight customary ketone-aldehyde resins possess a low melt viscosity and solution viscosity and hence one of their uses in coating materials is as film-forming functional fillers.

Ketone-aldehyde resins normally possess hydroxyl groups and can therefore be crosslinked only with, for example, polyisocyanates or amine resins. These crosslinking reactions are usually initiated and/or accelerated thermally.

Customary ketone-aldehyde resins are not suited to radiation-initiated crosslinking reactions in accordance with cationic and/or radical reaction mechanisms.

For this reason the ketone-aldehyde resins are usually used in radiation-curable coating systems as, for example, an additive film-forming component, but not as an additive crosslinking component. Owing to the uncrosslinked fractions, coatings of this kind often possess poor resistance with respect, for example, to gasoline and other chemicals or solvents.

DE 23 45 624, EP 736 074, DE 28 47 796, DD 24 0318, DE 24 38 724 and JP 09143396 describe the use of ketone-aldehyde resins and ketone resins, e.g., cyclohexanone-formaldehyde resins, in radiation-curable systems. Radiation-induced crosslinking reactions of these resins are not described. Ketone-formaldehyde resins as photoinitiators are also not described.

The polymer-analogous reaction of cyclohexanone-formaldehyde resins with azo compounds is described in Die Angewandte Makromolekulare Chemie, 168 (1989), p. 129 ff. The process is complicated for the industrial scale. Since azo compounds are used the preparation entails high safety impositions. Azo compounds, moreover, are thermally labile, and hence storage is complicated.

Journal of Applied Polymer Science, Vol. 72 (1999), p. 927 ff. describes cyclohexanone-formaldehyde and acetophenone-formaldehyde resins which become photoactive by virtue of the attachment of 10 mol % of benzoin or benzoin butyl ethers. The synthesis is complicated, since it takes place over two stages which last more than 16 hours. There is no assurance of full conversion, and so volatile constituents may be present. Moreover, low molecular mass fractions reduce the performance profile of high-grade coatings with respect to their mechanical properties.

It was an object of the present invention to prepare a radiation-sensitive composition comprising a binder component and low-odor, radiation-sensitive polymers which are suitable as polymeric photoinitiators and possess a low volatility, are widely compatible with different raw materials and easy to incorporate, a process for preparing them, and their use for initiating the UV-light-induced, free-radical crosslinking reaction of coating materials, adhesives, inks, gel coats, polishes, glazes, stains, pigment pastes, filling compounds, cosmetics articles, sealants and/or insulants. A further object was, through the use of these radiation-sensitive polymers, to enhance the gloss, solvent and chemical resistance, and hardness of these systems. Surprisingly it has proven possible to achieve this object, in accordance with the claims, through the provision of the radiation-sensitive composition of the invention, by preparing and using polymeric reaction products from aldehydes of the general formula I and ketones of the general formula II, with the use of further ketones if desired, in coating materials or adhesives, for example.

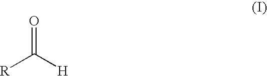

where R═H, branched or unbranched alkyl radical having 1 to 12 carbon atoms, or aryl radical,

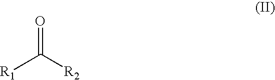

where R₁=unbranched alkyl radical having 1 to 12 carbon atoms and

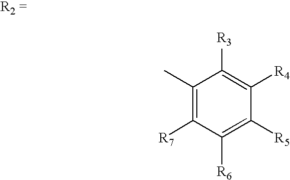

where R₃ to R₇═H, alkyl, OCH₃, OC₂H₅, Cl, F, COO(C₁-C₃ alkyl).
Additionally it is possible for R₄ to R₆ to be OH and/or SH.

The invention accordingly provides low-odor, radiation-sensitive, polymeric reaction products essentially comprising

the reaction product of
A) aldehydes of the general formula I

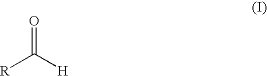

where R═H, branched or unbranched alkyl radical having 1 to 12 carbon atoms or aryl radical

and

B) at least one ketone of the general formula II

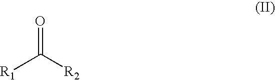

where R₁=unbranched alkyl radical having 1 to 12 carbon atoms
and

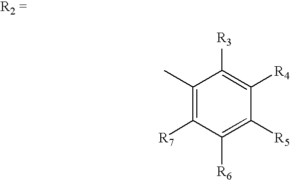

where the radicals R₃ to R₇ are H, alkyl, OCH₃, OC₂H₅, Cl, F, COO(C₁-C₃ alkyl), and R₄ to R₆ are additionally OH and/or SH
and
C) if desired, a further, CH-acidic ketone
for use as polymeric photoinitiators of low volatility in radiation-curing coating materials, adhesives, inks, gel coats, polishes, glazes, stains, pigment pastes, filling compounds, cosmetics articles, sealants and/or insulants.

Aldehydes suitable as aldehyde component A) according to formula I include in principle branched or unbranched aldehydes, such as formaldehyde, benzaldehyde, acetaldehyde, n-butyraldehyde and/or iso-butyraldehyde, valeraldehyde and also dodecanal, for example. Generally speaking it is possible to use any of the aldehydes said in the literature to be suitable for ketone-aldehyde resin syntheses. Preference is given, however, to using formaldehyde and benzaldehyde alone or in mixtures.

The required formaldehyde is normally used in the form of an approximately 20% to 40% strength by weight aqueous or alcoholic (e.g., methanolic or butanolic) solution. Other use forms of formaldehyde, such as the use of para-formaldehyde or else trioxane, for example, are likewise possible.

Examples of ketones B) according to formula II include acetophenone and its ring-substituted derivatives, such as hydroxyl-, methyl-, ethyl-, tert-butyl- and cyclohexyl-acetophenone.

In addition to component B) it is also possible for further ketones C) to be present, in a mixture, such as acetone, 4-tert-butyl methyl ketone, methyl naphthyl ketone, hydroxynaphthyl ketone, methyl ethyl ketone, heptan-2-one, pentan-3-one, methyl isobutyl ketone, propiophenone, cyclopentanone, cyclododecanone, mixtures of 2,2,4- and 2,4,4-trimethylcyclopentanone, cycloheptanone and cyclooctanone, cyclohexanone and all alkyl-substituted cyclohexanones having one or more alkyl radicals containing in total from 1 to 8 carbon atoms, individually or in a mixture. Examples of alkyl-substituted cyclohexanones include 4-tert-amylcyclohexanone, 2-sec-butylcyclohexanone, 2-tert-butylcyclohexanone, 4-tert-butylcyclohexanone, 2-methylcyclohexanone and 3,3,5-trimethylcyclohexanone.

Benzoin and/or its alkyl ethers, such as methyl, ethyl, propyl and isobutyl ethers, for example, can be used as component C) in a minor proportion, up to a maximum of 9.9 mol %, based on ketone components B) and C).

In general, however, it is possible to use any of the ketones said in the literature to be suitable for synthesizing ketone resins and ketone-aldehyde resins, and generally all CH-acidic ketones, as additional ketone C).

Preference is given to reaction products of formaldehyde and/or benzaldehyde with acetophenone, hydroxyl-, methyl-, tert-butyl- and/or cyclohexyl-acetophenone and also, if desired, 4-tert-butyl methyl ketone, cyclohexanone, 4-tert-butylcyclohexanone, 3,3,5-trimethyl-cyclohexanone and/or heptanone.

The synthesis of the polymers from components A), B) and, where used, C) takes place in a condensation reaction in a manner known from the literature in a basic medium (Dieter Stoye, Werner Freitag, Lackharze, Chemie, Eigenschaften und Anwendungen [Resins for Coatings; Chemistry, Properties, and Applications], Carl Manser Verlag, Munich, Vienna, 1996, p. 164 ff.; U.S. Pat. No. 2,540,885; U.S. Pat. No. 2,540,886; DE-PS 11 55 909; DL-PS 12 433; DE-PS 13 00 256; DE-PS 12 56 898; DE 33 24 287; DE 10 33 8580.0, EP 0 007 106; DE 12 65 415).

### Reaction Conditions:

### Solvent:

The reaction can be carried out using an auxiliary solvent. Alcohols such as methanol or ethanol, for example, have proven suitable. It is also possible to use water-soluble ketones as auxiliary solvents, such as methyl ethyl ketone or acetone, for example, which are then incorporated into the resin by reaction.

### Bases:

The products on which the invention is based are prepared from A), B) and, where used, C) using from 0.05 to 10 mol % (based on the ketone employed) of at least one base. Preference is given to (metal) hydroxides such as, for example, hydroxides of the cations NH₄, Li, Na and/or K. Particular preference is given to using potassium hydroxide and/or sodium hydroxide.

### Ratio of Ketone to Aldehyde Component:

The ratio between the ketone component (total B)+C)) and the aldehyde component A) may vary between 1:0.9 to 1:4. A preferred ketone/aldehyde ratio, however, is from 1:1 to 1:2.5. The ketone component and the aldehyde component can be added as they are or in solvents as mentioned above or in aqueous form. Particular preference is given to using an aqueous or alcoholic formaldehyde solution, trioxane and/or paraformaldehyde.

### Ratio of Ketone B) to Component C):

Based on the total of the ketones B) and C) used, the ketone component B) may be present in the range from 10 to 100 mol %, preferably between 20 to 90 mol %, more preferably between 25 and 80 mol %. The ketone component C) can be used in the range from 0 to 90 mol %, preferably from 10 to 80 mol %, more preferably from 20 to 75 mol %.

Through the nature and the proportion of the components with respect to one another it is easily possible to vary properties such as, for example, solubility properties in solvents of different polarity, compatibilities with other raw materials, softening ranges, glass transition temperatures or further functionalities, such as OH groups, for example, which are needed for the crosslinking of dual-cure systems composed of photopolymerizable binders, binders containing OH groups, and, for example, polyisocyanate crosslinkers.

The low odor, radiation-sensitive, polymeric reaction products of components A), B) and, where used, C), that are relevant to the invention, possess the following properties, depending on identity and on the ratio between ketones B) and C) and aldehydes A):
melting ranges between 30 and 160° C., preferably 40 and 150° C., more preferably 40 and 125° C.,
average molecular weights from 300 to 2000, more preferably from 400 to 1500 g/mol,
color numbers (according to Gardner, 50% in ethyl acetate) of less than 5, preferably less than 4, more preferably less than 3,
OH numbers of between 0 and 250 mg KOH/g, preferably between 0 and 200 mg KOH/g.

The invention also provides for the use of the products according to the invention for initiating the UV-light-induced, free-radical crosslinking reaction of radiation-curable coating materials, adhesives, inks, gel coats, polishes, glazes, stains, pigment pastes, filling compounds, cosmetics articles, sealants and/or insulants.

It has been found that proportions of between 5% and 80% by mass, preferably between 10% and 70% by mass, more preferably between 15% and 60%> by mass, based on the overall formulation, are advantageous.

It has also emerged that the products according to the invention possess broad compatibility with different raw materials and are easy to incorporate.

Suitable binder components of the radiation-curable coating materials, adhesives, inks, gel coats, polishes, glazes, stains, pigment pastes, filling compounds, cosmetics articles, sealants and/or insulants include in principle all of the unsaturated binders which are said to be suitable in the literature and are amenable to a free-radical crosslinking reaction. Examples include aromatic and aliphatic urethane acrylates, epoxy acrylates, polyester acrylates, acrylated polyacrylates, polyether acrylates, unsaturated polyesters, alkyd resins, and acrylated ketone-formaldehyde resins.

The radiation-curable coating materials, adhesives, inks, gel coats, polishes, glazes, stains, pigment pastes, filling compounds, cosmetics articles, sealants and/or insulants may further comprise reactive diluents.

Compounds which can be used with preference as reactive diluents include acrylic acid and/or methacrylic acid, C₁₋C₄₀ alkyl esters and/or cycloalkyl esters of methacrylic acid and/or acrylic acid, glycidyl methacrylate, glycidyl acrylate, 1,2-epoxybutyl acrylate, 1,2-epoxybutyl methacrylate, 2,3-epoxycyclopentyl acrylate and 2,3-epoxycyclopentyl methacrylate, and also the analogous amides; styrene and/or its derivatives may also be present.

Particular preference is given to phenoxyethyl acrylate, ethoxyethoxyethyl acrylate, isodecyl acrylate and isobornyl acrylate.

A further preferred class of radiation-reactive solvents are di, tri- and/or tetraacrylates and their methacrylic analogs, which originate formally from the reaction products of acrylic acid or methacrylic acid, respectively, and an alcohol component, with elimination of water. As the alcohol component customary for this purpose use is made, for example, of ethylene glycol, 1,2- and/or 1,3-propanediol, diethylene glycol, di- and tripropylene glycol, triethylene glycol, tetraethylene glycol, 1,2- and/or 1,4-butanediol, 1,3-butylethylpropanediol, 1,3-methylpropanediol, 1,5-pentanediol, 1,4-bis(hydroxymethyl)cyclohexane (cyclohexane-dimethanol), glycerol, hexanediol, neopentyl glycol, trimethylolethane, trimethylolpropane, pentaerythritol, bisphenol A, B, C, F, norbornylene glycol, 1,4-benzyldimethanol, 1,4-benzyldiethanol, 2,4-dimethyl-2-ethylhexane-1,3-diol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, trimethylolpropane, 3(4),8(9)-bis(hydroxymethyl)tricyclo[5.2.1.0^{2,6}]decane (Dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl) isocyanurate, mannitol, sorbitol, polypropylene glycols, polybutylene glycols, xylylene glycol or neopentyl glycol hydroxypivalate, alone or in mixtures.

Particular preference is given, however, to dipropylene glycol diacrylate (DPGDA) and/or tripropylene glycol diacrylate (TPGDA), hexanediol diacrylate (HDDA), and trimethylolpropane triacrylate, alone or in a mixture.

In general, however, it is possible to use any of the reactive diluents said in the literature to be suitable for radiation-curable coating materials.

The radiation-curable coating materials, adhesives, inks, gel coats, polishes, glazes, stains, pigment pastes, filling compounds, cosmetics articles, sealants and/or insulants can include, in combination with the polymeric, photoreactive compounds of the invention, further, commercially customary photoinitiators and/or photosensitizers.

These are derived, for example, from the group of the phenylglyoxylates, benzophenones, α-hydroxy ketones, α-amino ketones, benzil dimethyl ketals, monoacylphosphines, tertiary amines, bisacylphosphines, metallocenes and/or bisacyl ketones.

Examples are 2,4,6-trimethylbenzoyldiphenylphosphine, α,α-dimethoxy-α-hydroxyacetophenone, 2-methyl-1-(4-methylthio)phenyl-2-morpholinopropan-1-one, 1-hydroxycyclohexyl phenyl ketone, 4(4-methylphenylthiophenyl)phenylmethanone, phenyl tribromomethyl sulfone, 2-isopropylthioxanthone, 4-isopropylthioxanthone, benzophenone, ethyl 4-(dimethylamino)benzoate, methyl phenylglyoxylate, methyl benzoylbenzoate, diphenyl(3,4,6-trimethylbenzoyl)phosphine oxide, and substituted benzophenones, such as 4-methylbenzo-phenone, alone or in a mixture.

The radiation-curable coating materials, adhesives, inks, gel coats, polishes, glazes, stains, pigment pastes, filling compounds, cosmetics articles, sealants and/or insulants may also include auxiliaries and additives such as, for example, inhibitors, water and/or organic solvents, neutralizing agents, surface-active substances, oxygen scavengers and/or free-radical scavengers, catalysts, light stabilizers, color brighteners, thixotropic agents, antiskinning agents, defoamers, antistats, thickeners, thermoplastic additives, dyes, pigments, flame retardants, internal release agents, fillers and/or propel lams.

As well as the initiation of radiation-induced crosslinking reactions, the low-odor products according to the invention also improve, in particular, the gloss, solvent and chemical resistance, and hardness of coating materials, adhesives, inks, gel coats, polishes, glazes, stains, pigment pastes, filling compounds, cosmetics articles, sealants and/or insulants.

Atmospheric oxygen is a quencher of free radicals and so slows down the UV-light-induced crosslinking reaction; it may even lead to termination of the crosslinking of the polymers. In order to ensure effective curing in spite of this, present-day systems operate, for example, with large amounts of photoinitiator or else with waxes, which form a barrier layer between air and coating. A widespread method is that of curing in the absence of atmospheric oxygen, generally under an inert gas atmosphere, such as in a nitrogen, carbon dioxide or noble gas atmosphere, for example. All of the methods described of complete curing are either expensive or lead to further disadvantages. In the case of using wax the surface is matt and must therefore be polished where appropriate. Waxes also hinder effective adhesion of subsequent coats to the surface.

It is particularly noticeable that the surface hardness of coating materials which have not been cured in the absence of oxygen is extremely high. It is therefore possible in the case of UV-light-induced curing to dispense with an inert gas atmosphere or with the waxes described.

The examples which follow are intended to illustrate the invention but not to restrict the scope of its application:

### EXAMPLES

### Example 1

### Preparation of the Radiation-Sensitive, Polymeric Reaction Products

600 g of acetophenone, 108 ml of methanol, 200 g of Cavasol W 7 M (methylated β-cyclodextrin derivative, Wacker, Burghausen, DE) and 180 g of formalin (30% strength in water) are introduced to a three-necked flask and heated therein with stirring and under a nitrogen atmosphere to 50° C. 16 g of 25% strength sodium hydroxide solution are added, and the reaction mixture heats up to 70° C. Over 90 minutes 330 g of formalin (30% strength in water) are added and the reaction mixture is then heated to 95° C. and held under reflux for 5 h.

The aqueous phase is separated from the resin phase and the resin is washed to neutrality with water at 100° C. and freed in vacuo, at up to 150° C., from volatile constituents.

This gives a yellowish, clear and brittle resin which is soluble to 50% strength in methyl ethyl ketone, acetone, ethyl acetate and xylene and possesses a softening point of 48° C. The Gardner color number of a 50% strength solution in ethyl acetate is 2.2.

### Application Example

| Stock solution | A | B | C |
|---|---|---|---|
| Actilane 170¹⁾ | 250 | — | — |
| (aromatic urethane acrylate) | | | |
| Actilane 320¹⁾ | — | 250 | — |
| (acrylate ester) | | | |
| Actilane 370¹⁾ | — | — | 250 |
| (epoxy acrylate) | | | |
| TPGDA | 250 | 250 | 250 |
| Viscosity at 23° C. [mPa · s] | 4825 | 795 | 1250 |

¹⁾Akzo Nobel
TPGDA = tripropylene glycol diacrylate

| Varnish solution | A1 | A2 | B1 | B2 | C1 | C2 |
|---|---|---|---|---|---|---|
| Stock solution A | 50 | 50 | — | — | — | — |
| Stock solution B | — | — | 50 | 50 | — | — |
| Stock solution C | — | — | — | — | 50 | 50 |
| Reaction product from | 50 | — | 50 | — | 50 | — |
| Example 1 (40% in TPGDA) | | | | | | |
| Ebecryl ITX²⁾ | — | 10 | — | 10 | — | 10 |
| Remarks | | ITX | | ITX | | ITX |
| | | poorly | | poorly | | poorly |
| | | soluble | | soluble | | soluble |

²⁾UCB

The solutions were applied to glass plates using a drawdown frame and exposed six times for 6 s (TECHNIGRAF UV4/120/2 80W). The pure solutions A, B and C do not form a crosslinked film.

| | | film | König | MEK test |
|---|---|---|---|---|
| Varnish | | thickness | pendulum | (double |
| solution | Visual assessment of film | [um] | hardness¹⁾ | rubs)²⁾ |
| A1 | colorless, clear, glossy, | 34-48 | 43 | 130 |
| | very good flow | | | |
| A2 | yellow, clear, slightly matt, | 36-49 | 22 | 55 |
| | interspersed with pin holes | | | |
| B1 | colorless, clear, glossy, | 27-35 | 172 | >150 |
| | very good flow | | | |
| B2 | yellow, clear, glossy, | 28-34 | 90 | >150 |
| | good flow | | | |
| C1 | colorless, clear, glossy, | 28-39 | 113 | >150 |
| | very good flow | | | |
| C2 | yellow, clear, glossy, | 32-41 | 37 | 70 |
| | good flow | | | |

¹⁾in accordance with DIN EN ISO 1522
²⁾in the MEK test a cloth soaked with methyl ethyl ketone (MEK) is moved back and forth (double rubs) over the surface under test between said surface and a 1 kg test cushion. The number of rubs after which the coating changes is recorded.

1. A radiation-sensitive composition comprising a binder component and low-odor polymeric reaction products of comprising the reaction product of
A) aldehydes of the general formula I 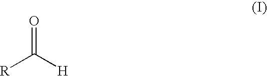
where R═H branched or unbranched alkyl radical having 1 to 12 carbon atoms or aryl radical
and
B) at least one ketone of the general formula II 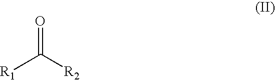
where R₁= unbranched alkyl radical having 1 to 12 carbon atoms
and 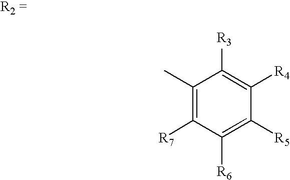
where the radicals R₃ to R₇ are H, alkyl, OCH₃, OC₂H₅, Cl, F, COO(C₁-C₃ alkyl), and
R₄ to R₆ are additionally OH and/or SH
and
C) if desired, a further, CH-acidic ketone.

2. The radiation-sensitive composition as claimed in claim 1,
wherein
formaldehyde, benzaldehyde, acetaldehyde, n-butyraldehyde and/or isobutyraldehyde, valeraldehyde and also dodecanal, alone or in combination, are used as aldehyde component A).

3. The radiation-sensitive composition as claimed in claim 1,
wherein
acetophenone and its ring-substituted derivatives, alone or in combination, are used as ketone component B).

4. The radiation-sensitive composition as claimed in claim 3,
wherein
hydroxyl-, methyl-, ethyl-, tert-butyl- or cyclohexyl-acetophenone, alone or in combination, are used as ring-substituted acetophenone derivatives.

5. The radiation-sensitive composition as claimed in claim 1,
wherein
acetone, 4-tert-butyl methyl ketone, methyl naphthyl ketone, hydroxynaphthyl ketone, methyl ethyl ketone, heptan-2-one, pentan-3-one, methyl isobutyl ketone, propiophenone, cyclopentanone, cyclododecanone, mixtures of 2,2,4- and 2,4,4-trimethylcyclopentanone, cycloheptanone, cyclooctanone, cyclohexanone and all alkyl-substituted cyclohexanones having one or more alkyl radicals containing in total from 1 to 8 carbon atoms, alone or in combination, are used as further CH-acidic ketone component under C).

6. The radiation-sensitive composition as claimed in claim 5,
wherein
4-tert-amylcyclohexanone, 2-sec-butylcyclohexanone, 2-tert-butylcyclohexanone, 4-tert-butylcyclohexanone, 2-methylcyclohexanone and 3,3,5-trimethylcyclohexanone, alone or in combination, are used as alkyl-substituted cyclohexanones.

7. The radiation-sensitive composition as claimed in claim 1,
wherein
a maximum of up to 9.9 mol % of the ketone component C), based on the sum of B) and C), can be replaced by benzoin or alkyl ethers.

8. The radiation-sensitive composition as claimed in claim 1.
wherein
the polymeric reaction products of components A), B) and, where used, C) have melting ranges between 30 and 160° C., average molecular weights of from 300 to 2000, color numbers (according to Gardner, 50% in ethyl acetate) of less than 5 and OH numbers of between 0 and 250 mg KOH/g.

9. The radiation-sensitive composition as claimed in claim 1,
wherein
the polymeric reaction products of components A), B) and, where used, C) are present in proportions of from 5% to 80% by mass, based on the overall formulation, in the radiation-sensitive composition.

10. The radiation-sensitive composition as claimed in claim 1,
wherein
unsaturated binders amenable to a free-radical crosslinking reaction are used as binder component.

11. The radiation-sensitive composition as claimed in claim 1,
wherein
aromatic and aliphatic urethane acrylates, epoxy acrylates, polyester acrylates, acrylated polyacrylates, polyether acrylates, unsaturated polyesters, alkyd resins and acrylated ketone-formaldehyde resins, alone or in combination, are used as binder component.

12. The radiation-sensitive composition as claimed in claim 1,
wherein
the radiation-sensitive composition comprises reactive diluents.

13. The radiation-sensitive composition as claimed in claim 1,
wherein
acrylic acid, methacrylic acid, C₁-C₄₀ alkyl esters, cycloalkyl esters of methacrylic acid, acrylic acid, glycidyl methacrylate, glycidyl acrylate, 1,2-epoxybutyl acrylate, 1,2-epoxybutyl methacrylate, 2,3-epoxycyclopentyl acrylate, 2,3-epoxycyclopentyl methacrylate and also the analogous amides, styrene and its derivatives, di-, tri- and/or tetraacrylates and their methacrylic analogs, which result formally from the reaction products of acrylic acid or methacrylic acid, respectively, and an alcohol component, with elimination of water, alone or in combination, are used as reactive diluents.

14. The radiation-sensitive composition as claimed in claim 13,
wherein
ethylene glycol, 1,2- and/or 1,3-propanediol, diethylene glycol, di- and tripropylene glycol, triethylene glycol, tetraethylene glycol, 1,2- and/or 1,4-butanediol, 1,3-butylethyl-propanediol, 1,3-methylpropanediol, 1,5-pentanediol, 1,4-bis(hydroxymethyl)cyclohexane (cyclohexanedimethanol), glycerol, hexanediol, neopentyl glycol, trimethylolethane, trimethylolpropane, pentaerythritol, bisphenol A, B, C, F, norbornylene glycol, 1,4-benzyldimethanol, 1,4-benzyldiethanol, 2,4-dimethyl-2-ethylhexane-1,3-diol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, trimethylolpropane, 3(4),8(9)-bis(hydroxymethyl)tricyclo[5.2.1.0^{2,6}]decane (Dicidol), 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4(2,4,4)-trimethylhexane-1,6-diol, hexane-1,2,6-triol, butane-1,2,4-triol, tris(β-hydroxyethyl) isocyanurate, mannitol, sorbitol, polypropylene glycols, polybutylene glycols, xylylene glycol or neopentyl glycol hydroxypivalate, alone or in mixtures, are used as alcohol component for the reactive diluents.

15. The radiation-sensitive composition as claimed in claim 1,
wherein
the radiation-sensitive composition comprises further photoinitiators and/or photosensitizers.

16. The radiation-sensitive composition as claimed in claim 1,
wherein
phenylglyoxylates, benzophenones, α-hydroxy ketones, α-amino ketones, benzil dimethyl ketals, monoacylphosphines, tertiary amines, bisacylphosphines, metallocenes and bisacyl ketones, alone or in combination, are used as photoinitiators and/or photosensitizers.

17. A process for preparing a radiation-sensitive composition,
which comprises
using a binder component and low-odor polymeric reaction products comprising the reaction product of
A) aldehydes of the general formula I 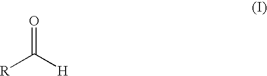
where R═H, branched or unbranched alkyl radical having 1 to 12 carbon atoms or aryl radical
and
B) at least one ketone of the general formula If 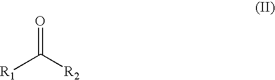
where R₁=unbranched alkyl radical having 1 to 12 carbon atoms 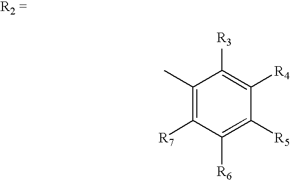
and
where the radicals R₃ to R₇ are H, alkyl, OCH₃, OC₂H₅, Cl, F, COO(C₁-C₃ alkyl), and
R₄ to R₆ are additionally OH and/or SH
and
C) if desired, a further, CH-acidic ketone.

18. A formulation for UV-light induced, free radical crosslinking reaction comprising the radiation-sensitive composition as claimed in claim 1, wherein the formulation for UV-light induced, free radical crosslinking reaction is one selected from the group consisting of a coating material, an adhesive, an ink, a gel coat, a polish, a glaze, a stain, a pigment paste, a filling compound, a cosmetics article, a sealant and an insulant.

19. The formulation for UV-light induced, free radical crosslinking reaction as claimed in claim 18, further comprising as auxiliaries and additives inhibitors, water and/or organic solvents, neutralizing agents, surface-active substances, oxygen scavengers and/or free-radical scavengers, catalysts, light stabilizers, color brighteners, thixotropic agents, antiskinning agents, defoamers, antistats, thickeners, thermoplastic additives, dyes, pigments, flame retardants, internal release agents, fillers and/or propellants, alone or in combination.
